(19) United States
(12) Patent Application Publication
(10) Pub. No.: US 2003/0091864 A1
(43) Pub. Date: May 15, 2003

(54) Lamination comprising oxide layer, magnetoresistive head using the same, and magnetic recording and reproducing device

(76) Inventors: Katsumi Hoshino, Matsuda (JP); Takao Imagawa, Mito (JP); Satoshi Shigematsu, Yokohama (JP); Hiroyuki Hoshiya, Odawara (JP)

Correspondence Address: REED SMITH LLP, Suite 1400, 3110 Fairview Park Drive, Falls Church, VA, 22042, US

(21) Appl. No.: 10/292,544

(22) Filed: Nov. 13, 2002

(30) Foreign Application Priority Data
Nov. 13, 2001 (JP) P2001-346850

(51) Int. Cl. B32B 9/00

(52) U.S. Cl. 428/692; 428/694 EC; 428/694 TM; 428/694 MM

(57) ABSTRACT

An oxide layer or a mixture layer of an oxide and a magnetic body is formed on an interface between an antiferromagnetic coupling layer and a ferromagnetic layer in a synthetic ferrimagnetic structure. In this case, antiferromagnetic coupling between the ferromagnetic layer and another ferromagnetic layer does not deteriorate considerably. This structure is used for a magnetization fixed layer or a free ferromagnetic layer in a spin valve, whereby a high-output magnetic head and a high-output magnetic disc device can be produced.

### BACKGROUND OF THE INVENTION

1. Field of the Invention

The present invention relates to a magnetic head and magnetic recording and reproducing device which can cope with a high magnetic recording density.

2. Background of the Invention

With a rise in magnetic recording density, a spin valve element has been used as a reproducing head of a Hard Disk Drive (HDD) device. Up to the present, the reproducing output thereof has been improved by improvement in the layer structure thereof. The layer structure of a spin valve has the following structure: an antiferromagnetic layer/a ferromagnetic layer/a nonmagnetic intermediate layer/a free ferromagnetic layer. The magnetization of this ferromagnetic layer is fixed by an exchange coupling magnetic field generated in the interface between the antiferromagnetic layer and the ferromagnetic layer, and the magnetization of the free ferromagnetic layer is reversed by an external magnetic field so that the direction of the magnetization of the ferromagnetic layer is relatively changed. Simultaneously, a magnetic field is detected through the change in electrical resistance. In recent years, it has been reported that the output of the spin valve is considerably improved by using an oxide film as an electron reflecting layer near the magnetization fixed layer or the free ferromagnetic layer, i.e., the so-called “specular effect”.

Examples of an oxide film arranged as an electron reflecting layer near a free ferromagnetic layer are described in JP-A No. 15630/2000 (Title of the Invention: “Laminated Thin Film Functional Device and Magnetoresistance Effect Element”) which discloses a layer made of an oxide of Co, Fe, Ni or the like, and JP-A No. 276710/2000 (Title of the Invention: “Magnetoresistance Effect Element, Magnetoresistance Effect Head, and Hard Disc Device using the Magnetoresistance Effect Head”) which discloses a layer made of an oxide such as NiO, Fe₂O₃, or Al₂O₃. Furthermore, the Journal of the Magnetics Society of Japan (Vo. 125, No. 4 (2001)) (Title: Magnetoresistance Effect and Interlayer Bonding Depending on Structure of Back Film/Protective Film of Spin Valve Film) discloses a spin valve film using a layer made of an oxide of Ta.

Examples of an oxide film inserted into a magnetization fixed layer are described in JP-A No. 156530/2000 (Title of the Invention: Laminated Thin Film Functional Device, and Magnetoresistance Effect Element) and JP-A No. 252548/2000 (Title of the Invention: Magnetoresistance Effect Element, and Magnetic Recording Device) which disclose a magnetization fixed layer structure comprising a sandwich structure of a ferromagnetic layer/an oxide layer/a ferromagnetic layer, or a five-layer structure of a ferromagnetic layer/an oxide layer/a ferromagnetic layer/an antiferromagnetic coupling layer/a ferromagnetic layer.

As described, several examples of a spin valve using the specular effect are reported. However, in the case in which the specular effect is used in a magnetization fixed layer, when the three-layer structure of [a first ferromagnetic layer/an oxide layer/a second ferromagnetic layer] is adopted as described above, ferromagnetic coupling between the two ferromagnetic layers across the oxide layer becomes weak. Consequently, the magnetization of the first ferromagnetic layer on the oxide is reversed even by a low external magnetic field. Thus, the stability of the magnetization fixed layer against external magnetic fields deteriorates. In the five-layer structure of [a first ferromagnetic layer/an oxide layer/a first ferromagnetic layer/an antiferromagnetic coupling layer/a second ferromagnetic layer] as a synthetic ferromagnetic structure, ferromagnetic coupling between the two first ferromagnetic layers across the oxide layer also becomes weak. Following this, the magnetizations of the second ferromagnetic layer and the first ferromagnetic layer contacting the antiferromagnetic coupling layer can be kept anti-parallel even if a relatively high magnetic field is applied thereto. However, the magnetization of the first ferromagnetic layer on the opposite side is easily reversed even when a low external magnetic field is applied thereto. Therefore, in the case in which such a structure is used for a magnetization fixed layer of a spin valve, problems are caused.

### SUMMARY OF THE INVENTION

The inventors have discovered that in a synthetic ferrimagnetic structure comprising a first ferromagnetic layer, an antiferromagnetic coupling layer and a second ferromagnetic layer, the inclusion of an oxide layer (preferably an iron oxide) or a mixture layer of an oxide and a ferromagnetic material on the interface between the antiferromagnetic coupling layer and the second ferromagnetic layer prevents any significant reduction of the antiferromagnetic coupling between the first and second ferromagnetic layers. This synthetic ferrimagnetic structure of the present invention improves the magnetoresistance ratio and is stable when used as the pinned (i.e., fixed) or free layer of a spin valve. Moreover, because the size of crystal grains on the oxide layer becomes small, the soft magnetic property of the free layer is also improved. The synthetic ferrimagnetic structure of the present invention may be used to produce a high output magnetoresistive element which, when combined with an inductive thin film magnetic head, produces the superior, high output magnetoresistive head of the present invention. Furthermore, a magnetic recording and reproducing device on which the magnetic head of the present invention is mounted also provides superior properties. The synthetic ferrimagnetic structure of the present invention is also effective for controlling crystal grains in a multilayered magnetic recording medium.

Other and further objects, features and advantages of the present invention will appear more fully from the following description.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 is a cross-sectional view of a synthetic ferrimagnetic structure of the present invention;

FIG. 2 is a cross-sectional view of a conventional synthetic ferrimagnetic structure;

FIGS. 3A and 3B are graphs showing magnetization curves of two synthetic ferrimagnetic structures according to FIG. 1 having oxide layers of two different thicknesses;

FIGS. 3C and 3D are graphs showing magnetization curves of two conventional synthetic ferrimagnetic structures;

FIG. 4 is a cross-sectional view of a high-output spin valve of the present invention;

FIG. 5 is a graph showing the dependency of magnetoresistive ratio on the film thickness of Fe, CoFe;

FIG. 6 is a cross-sectional view of another high-output spin valve of the present invention;

FIG. 7 is a perspective view of a magnetoresistive head of the present invention;

FIG. 8A is a schematic view of a magnetic recording and reproducing device of the present invention; and

FIG. 8B is a cross-sectional view of a magnetic recording and reproducing device of the present invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. The detailed description will be provided herein below with reference to the attached drawings.

### EXAMPLE 1

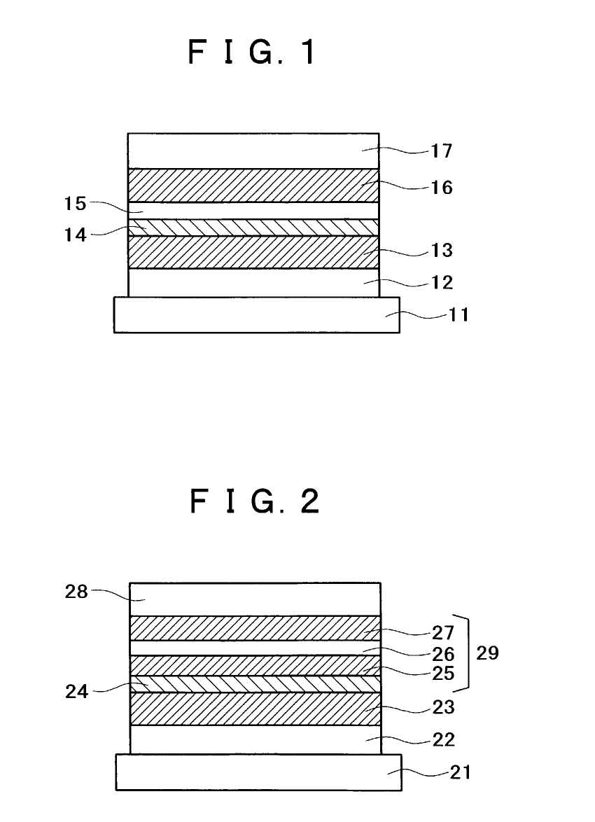

In at least one preferred embodiment of the present invention, a high-frequency magnetron sputtering was used to produce a multilayered film. The vacuum degree was set to 10⁻⁵ Pa or less. A portion of the cross-section of the formed multilayered synthetic ferrimagnetic structure is shown in FIG. 1. The substrate layer 11 comprises a glass substrate. After the substrate 11 was cleaned, NiFe (2 nm)/Ta (3 nm) was used as a buffer layer 12. Thereon, Co-10 atomic % Fe (1.2 nm), Ru (0.8 nm), and Co-10 atomic % Fe (2 nm) were formed as a first ferromagnetic layer 13, an antiferromagnetic coupling layer 14, and a second ferromagnetic layer 16, respectively. The oxide layer 15 is preferably disposed between the antiferromagnetic coupling layer 14 and the second ferromagnetic layer 16 and is formed by exposing a layer of Fe deposited on the antiferromagnetic coupling layer 14 to oxygen to form the layer of Fe-oxide prior to the formation of the second ferromagnetic layer 16. Two thicknesses of the Fe layer of 0.6 nm and 1.5 nm were set to form the Fe-oxide layers 15. Finally, a protective film 17 made of Ta (3 nm) was formed. These two samples are referred to as Samples A and B. A multilayered film shown in FIG. 2 was also formed. A substrate 21 comprises a glass substrate was used. After the substrate was cleaned, NiFe (2 nm)/Ta (3 nm) was used as a buffer layer 22. Thereon, Co-10 atomic % Fe (1.2 nm) and Ru (0.8 nm) were formed as a first ferromagnetic layer 23 and an antiferromagnetic coupling layer 24, respectively. Thereon, a sandwich film of a ferromagnetic layer 25/an oxide layer 26/a ferromagnetic layer 27 was used as a second ferromagnetic layer 29. Specifically, Co-10 atomic % Fe (1 nm) and Fe (0.6 nm) were formed as the layers 25 and 26, respectively. Thereafter, the lamination was naturally oxidized and then Co-10 atomic % Fe (2 nm) was formed thereon. Finally, a protective film 28 made of Ta (3 nm) was formed. This sample is referred to as Sample C. Furthermore, a sample for comparison was also formed without forming the oxide layer 15 in FIG. 1. This sample is referred to as sample D.

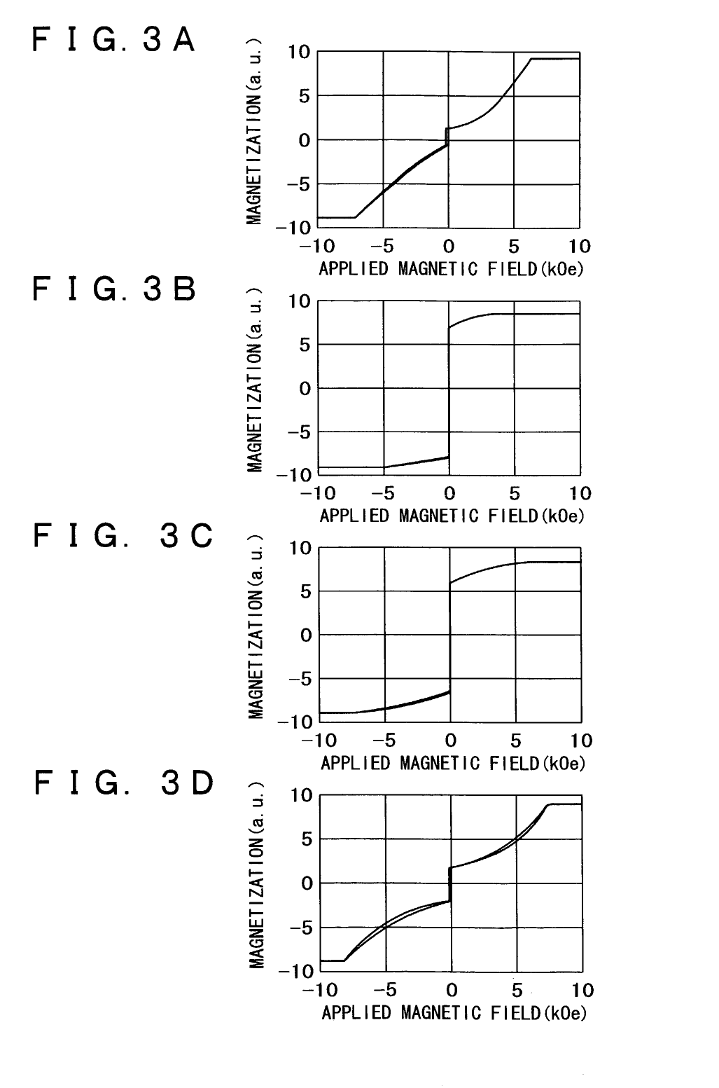

Magnetization curves of these samples are shown in FIGS. 3A to 3D. In the case in which the first ferromagnetic layer is antiferromagnetically coupled to the second ferromagnetic layer, a magnetization curve of Comparative example (shown in FIG. 3D), that is, Sample D is obtained. About Sample A, substantially the same magnetization curve is obtained as shown in FIG. 3A. Thus, it appears that the first ferromagnetic layer is antiferromagnetically coupled to the second ferromagnetic layer. About Sample B, the quantity of magnetization reversed at a zero magnetic field is very large as shown in FIG. 3B. It appears that this is because oxidization of Fe does not advance sufficiently and a structure of Fe/Fe oxide/a second ferromagnetic layer is formed on Ru. In other words, since magnetic coupling between Fe and the second ferromagnetic layer 16 across Fe oxide is weak, the magnetization of the second ferromagnetic layer is reversed by a low external magnetic field so that the anti-parallel state of the magnetizations of the second and first ferromagnetic layers is realized only in a low magnetic field range. In the case of Sample C, the Fe layer is sufficiently oxidized for the same reason. However, the ferromagnetic layer 25 contacting Ru is antiferromagnetically coupled to the first ferromagnetic layer 23. As shown in FIG. 3C, magnetic coupling between the ferromagnetic layer 25 contacting Ru and the ferromagnetic layer 27 not contacting Ru across the oxide layer 26 is weak. For this reason, the magnetization of the ferromagnetic layer 27 not contacting Ru is reversed by a low external magnetic field. Thus, in the ferromagnetic layer 27 not contacting Ru and the first ferromagnetic layer 23, the anti-parallel state of the magnetizations is realized only in a low magnetic field range.

As described above, it can be understood that interaction between the two ferromagnetic layers in the synthetic ferrimagnetic structure is largely changed dependently on the position where the oxide is inserted. Even if the oxide layer is put on the interface between the antiferromagnetic coupling layer and the ferromagnetic layer, a relatively intense antiferromagnetic coupling is observed between the two ferromagnetic layers. However, if the oxide is inserted in the middle of the ferromagnetic layer (as shown in FIG. 2), magnetic coupling between the ferromagnetic layers formed on and beneath the oxide becomes weak. Thus, it can be understood that it is difficult to make the magnetizations of the ferromagnetic layers on and beneath the antiferromagnetic coupling layer into an anti-parallel state. From the above-mentioned results, it can be expected that by using the synthetic ferrimagnetic structure of the present invention, i.e., the structure of a first ferromagnetic layer/an oxide layer/an antiferromagnetic coupling layer/a second ferromagnetic layer for a multilayered recording medium or a spin valve, properties thereof are improved.

An example wherein the present invention is used for a multilayered recording medium is described below. As a substrate 11 in FIG. 1, a glass substrate or an Al substrate is used. A buffer layer 12 made of CrMo or the like is formed. Thereon, the following are successively formed: CoCrPt, CoCrTa, or the like as a first ferromagnetic layer 13, Ru as an antiferromagnetic coupling layer 14, an oxide of Fe as an oxide layer 15, CoCrPt, CoCrTa or the like as a second ferromagnetic layer 16, and C as a protective layer. By making the synthetic ferrimagnetic structure, a multilayered recording medium superior in recording and reproducing ability can be formed on the basis of an effect of an increase in apparent anisotropic magnetic field Hk and an effect that the size of crystal grains is made minute by the insertion of the oxide.

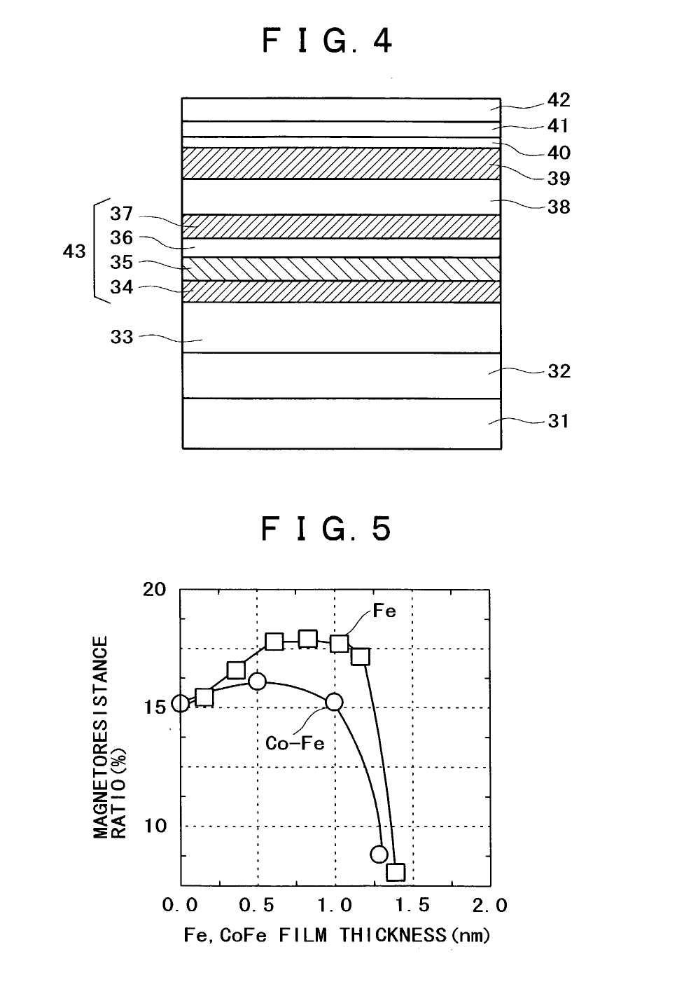

The following will describe an example wherein the synthetic ferrimagnetic structure of the present invention is used in a magnetization fixed layer of a spin valve useful as a magnetoresistive head of an HDD device. The layered structure of this example is illustrated in FIG. 4. As a substrate 31, a glass substrate was used. After the substrate was cleaned, NiFeCr (5 nm) and Mn-50 atomic % Pt alloy (10 nm) were used as a buffer layer 32 and an antiferromagnetic film 33, respectively. A magnetization fixed layer 43 was made to have the synthetic ferrimagnetic structure of the present invention. As a first ferromagnetic layer 34 and an antiferromagnetic coupling layer 35, Co-10 atomic % Fe (1.2 nm) and Ru (0.8 nm), respectively, were formed. Then, Fe or Co-10 atomic % Fe was formed on layer 35 and the resultant was exposed to oxygen to form an oxide layer 36 of Fe or Co-10 atomic % Fe. A second ferromagnetic layer 37 of Co-10 atomic % Fe (2 nm) was then formed on the oxide layer 36 so that the oxide layer 36 is disposed on the interface between the antiferromagnetic coupling layer 35 and the second ferromagnetic layer 37. On the second ferromagnetic layer 37, Cu (2 nm), Co-10 atomic % Fe (2 nm), and Cu (0.6 nm) were successively formed as a nonmagnetic intermediate layer 38, a free ferromagnetic layer 39, and a conductive nonmagnetic layer 40, respectively. As an oxide layer 41, Ta (1 nm) was formed and then oxidized. Thereafter, Ta (2 nm) was formed as a protective layer 42. For comparison, a sample was produced without forming any oxide layer 36 on the interface between the antiferromagnetic coupling layer 35 and the second ferromagnetic layer 37.

FIG. 5 shows relationship between the film thickness of the oxide layer 36 comprising either Fe or CoFe and the magnetoresistance ratio. In the case in which CoFe was oxidized to form the oxide layer 36, a slight increase in the magnetoresistance ratio was observed in the range where the film thickness of CoFe oxide layer 36 was 1 nm or less. When the film thickness became 1 nm or more, the magnetoresistance ratio decreased sharply. In the case in which Fe was oxidized to form the oxide layer 36, the MR ratio was higher where the film thickness of Fe was 1 nm or less than when the film thickness was 0 nm (i.e., in the sample where no Fe was formed). It appears that the reason why the MR ratio dropped sharply in the range where the film thickness of the Fe or CoFe oxide layer 36 was 1 nm or more is as follows: the magnetic layer was not sufficiently oxidized and the layer structure thereof became a structure of [Fe remaining after the oxidization/an oxide of Fe/CoFe] or [CoFe remaining after the oxidization/an oxide of CoFe/CoFe] so that ferromagnetic coupling between the CoFe(Fe) remaining after the oxidization and the CoFe across the oxide of CoFe(Fe) was weak and thus magnetization of the second ferromagnetic layer 37 of CoFe on the side of the intermediate layer 38 was rotated in a low magnetic field. In the case in which the oxide of Fe is used, a higher magnetoresistance ratio is given, as compared with the case of the use of CoFe.

In the present example, the oxide of Fe was used. However, substantially the same effect can be obtained if a metal material made mainly of Fe is used. As the buffer layer 32, NiFeCr was used. However, no problems are caused even if NiFeCr/Ta, NiFe/NiFeCr, Ta, NiFe/Ta or the like is used. This is because MnPt is crystal-oriented to function as an antiferromagnetic film. While Mn—Pt was used as the antiferromagnetic film 33, other Mn-based materials such as Mn—Pd, Mn—Ir, or Mn—Ni may also be used. While Ru was used as the antiferromagnetic coupling film 35, substantially the same effect can be obtained using Cr, Ir or a metal film made mainly of Ru.

Different materials may be used for the first and second ferromagnetic layers. Co-10 atomic % Fe was used as the first ferromagnetic layer 34 and the second ferromagnetic layer 37 of the magnetization fixed layer 43. However, other materials such as a Co—Fe based material wherein the composition thereof is changed, Fe, NiFe, Co—NiFe or the like material may also be used as long as antiferromagnetic coupling is generated between the two ferromagnetic layers.

As the magnetization free layer 39, the single-layered film of Co-10 atomic % Fe (2 nm) was used. However, a bi-layered film of CoFe/NiFe or a single-layered film of Co—Ni—Fe may also be used.

As the conductive nonmagnetic layer 40, Cu (0.6 nm) was used. However, some other conductive material, such as Au, Ru, Pd or Pt, may be used. Even if no conductive nonmagnetic layer is used, no problem arises.

As the oxide layer 41, the oxide of Ta was used. However, the specular effect can be obtained even if some other oxide, such as an oxide of Mn, Nb, Cr, Mn or Al, is used.

In the present example, the results obtained by sending electric current in the in-plane direction of the film have been shown. Substantially the same results would be obtained when an electric current is sent in the direction perpendicular to the film plane.

### EXAMPLE 2

The following will describe another example wherein a synthetic ferrimagnetic structure produced in the same process as in Example 1 was used for the magnetization fixed layer of a spin valve. The film structure of this example is the same as illustrated in FIG. 4. As a substrate 31, a glass substrate was used. After the substrate was cleaned, NiFeCr (5 nm) and Mn-50 atomic % Pt alloy (10 nm) were used as a buffer layer 32 and an antiferromagnetic magnetic film 33, respectively. The magnetization fixed layer 43 was made to have the synthetic ferrimagnetic structure of the present invention. As a first ferromagnetic layer 34, an antiferromagnetic coupling layer 35, and a second ferromagnetic layer 37, Co-10 atomic % Fe (1.2 nm), Ru (0.8 nm), and Co-10 atomic % Fe (2 nm), respectively, were used. A magnetic material chip was put on an oxide target and then sputtered onto the interface between the antiferromagnetic coupling layer 35 and the second ferromagnetic layer 37, so as to form an oxide layer 36. The film thickness thereof was made constant (1 nm). On the second ferromagnetic layer 37, Cu (2 nm), Co-10 atomic % Fe (2 nm), and Cu (0.6 nm) were successively formed as a nonmagnetic intermediate layer 38, a free ferromagnetic layer 39, and a conductive nonmagnetic layer 40, respectively. As an oxide layer 41, Ta (1 nm) was formed and then oxidized. Thereafter, Ta (2 nm) was formed as a protective layer 42. The magnetoresistance ratios of these films were measured. These results are shown in Table 1.

TABLE 1

| | | Magnetoresistance |
|---|---|---|
| Target | Chip | ratio (%) |
| NiO | None | 2.5 |
| | Fe 10 chips | 15.7 |
| | Co 10 chips | 14.5 |
| CoO | None | 2.2 |
| | Fe 10 chips | 16.0 |
| | Co 10 chips | 14.3 |
| Fe₃O₄ | None | 17.2 |
| | Fe 10 chips | 17.7 |
| | Co 10 chips | 15.2 |
| Comparative Example | | 14.8 |

In this film structure, the magnetoresistance ratio of the sample having no oxide layer 36 was 14.8%. As shown in Table 1, although CoO, NiO or the like are antiferromagnetic materials, in the case in which such an oxide is applied as the oxide layer 36, antiferromagnetic coupling cannot be obtained between the first ferromagnetic layer 34 and the second ferromagnetic layer 37. Therefore, the magnetoresistance ratio is very low. In the case in which the chips of each of Fe and Co were put, a relatively high magnetoresistance ratio was obtained. It appears that this is because antiferromagnetic coupling was obtained between the first ferromagnetic layer 34 and the second ferromagnetic layer 37 by forming a mixture with the magnetic metal. In the case in which the Co chips were put, the magnetoresistance ratio was slightly low. However, it appears that the magnetoresistance increases by making the number of the Co chips optimal. In the case in which Fe chips were put, the effect was high. Furthermore, in the case in which the Fe chips or Co chips were put on the Fe₃O₄ target, a higher magnetoresistance ratio was obtained.

In the present example, the production of Fe₃O₄ by sputtering has been described. It appears that the formed film structure was not complete Fe₃O₄ but a mixture of Fe oxides such as Fe₃O₄ and Fe₂O₃, and that if complete Fe₃O₄ can be formed, a higher magnetoresistance ratio can be obtained. Even if γ-Fe₂O₃, FeO, MFe₂O₄ (M=Fe, Co, Ni, Mn, Cr or Zn) or the like is used instead of Fe₃O₄, substantially the same effects can be obtained. In the present example, targets of NiO, CoO and Fe₂O₃ were used. However, even if a target of an oxide of Mn, Cr, Cu, Zn or the like is used, substantially the same results can be obtained. In the present example, the magnetic metal chips were put on the oxide target to form the film. However, a chip of an oxide such as NiO, Fe₃O₄, or ZnO may be put on a magnetic target made of Fe, Ni, Co, Ni—Fe, CoFe or the like to form a film.

### EXAMPLE 3

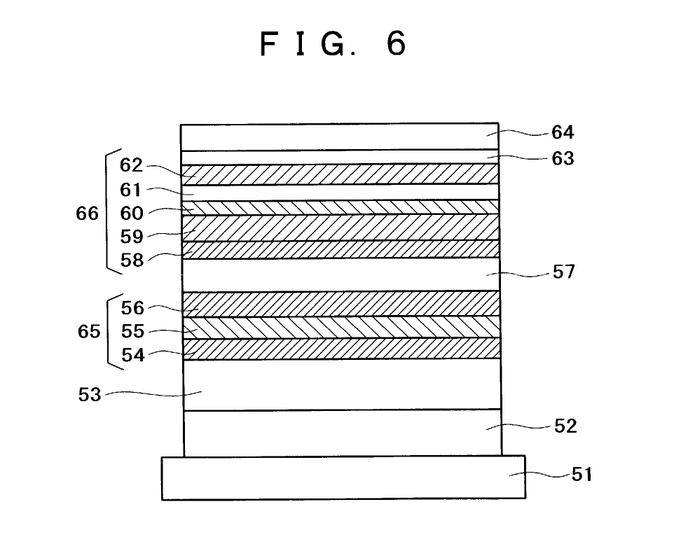

The following will describe another example wherein a synthetic ferrimagnetic structure of the present invention produced in the same process as in Example 1 was used for a magnetization free layer of a spin valve. A multilayered film is illustrated in FIG. 6. As a substrate 51, a glass substrate was used. After the substrate was cleaned, NiFeCr (5 nm) and Mn-50 atomic % Pt alloy (10 nm) were used as a buffer layer 52 and an antiferromagnetic film 53, respectively. A magnetization fixed layer 65 was made to have a synthetic ferromagnetic structure. As a first ferromagnetic layer 54, an antiferromagnetic coupling layer 55, and a second ferromagnetic layer 56, Co-10 atomic % Fe (1.2 nm), Ru (0.8 nm), and Co-10 atomic % Fe (2 nm), respectively, were used. As a nonmagnetic intermediate layer 57, Cu (2 nm) was used. A free ferromagnetic layer 66 was also made to have a synthetic ferrimagnetic structure. In the film structure thereof, from the side of the substrate, a bilayered film of Co-10 atomic % Fe (0.5 nm)/NiFe (2 nm), Ru (0.8 nm), and NiFe (1.0 nm) were formed as first ferromagnetic layers 58/59, an antiferromagnetic coupling film 60, and a second ferromagnetic layer 62, respectively. On the interface between the antiferromagnetic coupling film 60 and the second ferromagnetic layer 62, Fe (1 nm) was formed. The Fe was exposed to oxygen to form a layer 61 made of an iron oxide. On the second ferromagnetic layer 62, Cu (0.6 nm) and Ta (2 nm) were successively formed as a conductive nonmagnetic layer 63 and a protective layer 64, respectively. For comparison, a magnetoresistive multilayered film was formed without forming the Fe oxide magnetic layer 61. Properties of these films are shown in Table 2.

TABLE 2

| | | Free layer |
|---|---|---|
| | Magnetoresistance | Coercive |
| | ratio (%) | force (Oe) |
| Oxide layer formed | 12.8 | 3.5 |
| No oxide layer | 11.2 | 1.8 |
| (Comparative Example) | | |

As understood from Table 2, by inserting the oxide layer into the free ferromagnetic layer 66, the magnetoresistance ratio was improved without significant deterioration of the synthetic ferrimagnetic structure. In the present example, the synthetic ferrimagnetic structure of CoFe/NiFe/Ru/Fe-oxide/NiFe was used. However, in film structures of CoFe/Ru/Fe-oxide/NiFe, CoFe/Ru/Fe-oxide/CoFe/NiFe and the like, substantially the same results were obtained.

### EXAMPLE 4

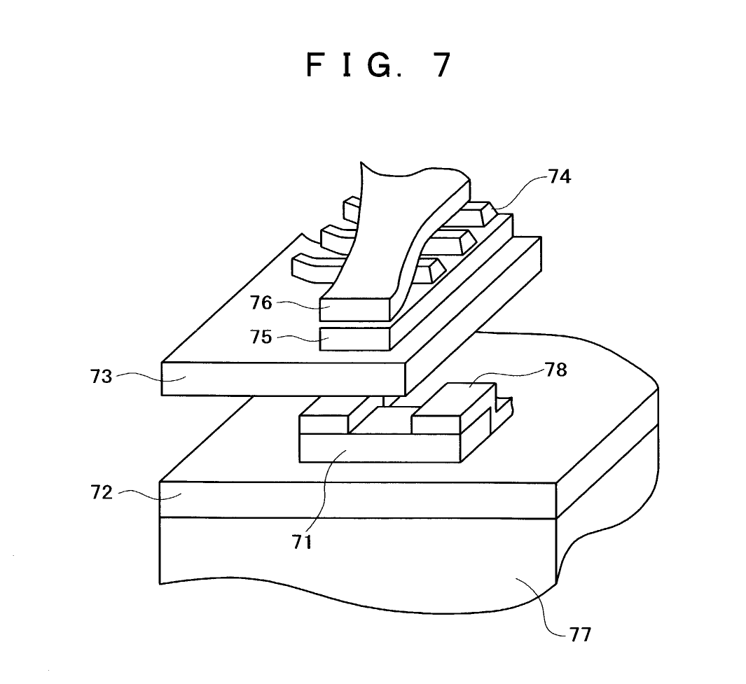

A magnetoresistive head comprising the magnetoresistive element 71 of Example 1 and a recording head were combined as described below. FIG. 7 is a perspective view showing a portion of the recording and reproducing separation type head of the present invention. The recording and reproducing separation type head consists of reproducing head including a lower magnetic shield 72, a magnetoresistive element 71 comprising the synthetic ferromagnetic structure of the present invention as described above in Example 1, a magnetic domain control film (not shown) and electrodes 78 which are formed on the substrate 77, and the recording head including lower magnetic core 75, upper magnetic core 76 and coil 74. The magnetoresistive element 71 comprises the synthetic ferrimagnetic structure of the present invention as described above in Example 1. As a coil 74 of the recording head, Cu produced by an electroplating method was used. As a lower magnetic core 75 and an upper magnetic core 76, a 46 weight % Ni—Fe film and a Co—Ni—Fe film, respectively, which were produced by an electroplating method, were used. As a magnetic gap film and a protective film of the recording head, Al₂O₃ films were used. The track width of the recording head and that of the reproducing head were set to 30 μm and 22 μm, respectively.

The magnetic head of the present invention produces higher output than a conventional magnetic head. While the head of Example 1 was used in this Example 4, any of the magnetoresistive heads described in Examples 2 and 3 can be employed to obtain substantially the same results.

### EXAMPLE 5

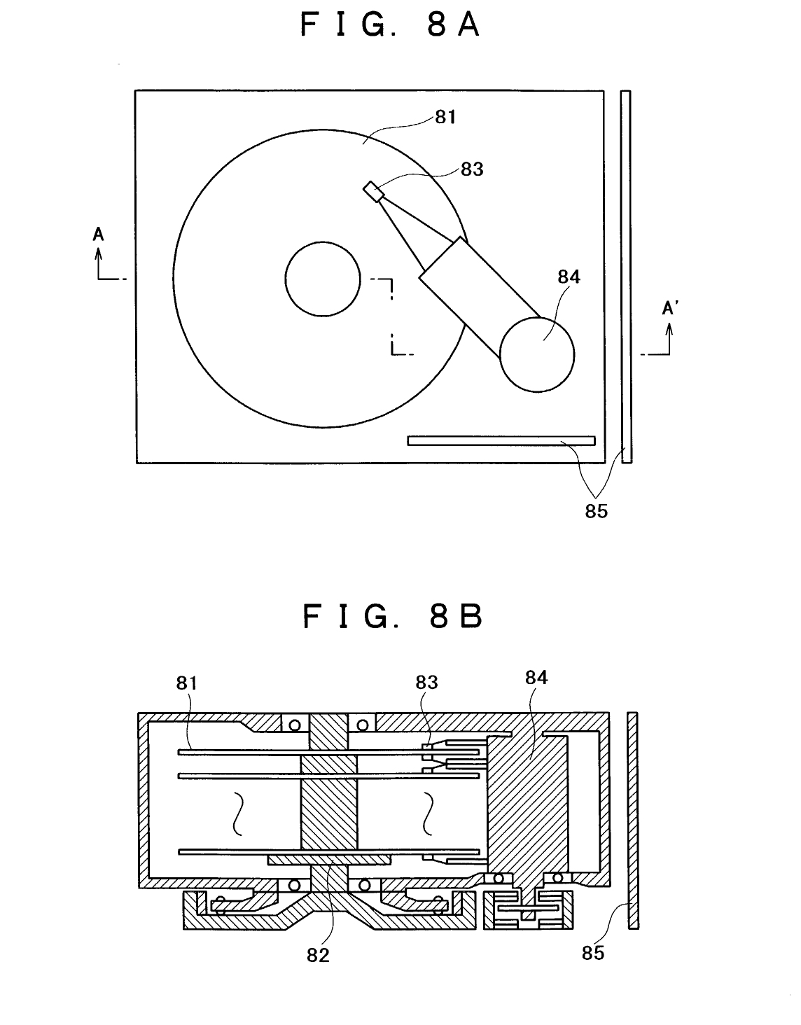

A recording and reproducing separation head of the present invention was used to produce a magnetic disc device. FIGS. 8A and 8B are schematic views of the structure of the magnetic disc device of the present invention. For a magnetic recording medium 81, a material made of a Co—Cr—Pt alloy and having a coercive force of 4.3 kOe was used. As a magnetic head 83, the magnetic head produced in Example 4 was used. This made it possible to produce a high-output magnetic head and produce a magnetic disc device having a high recording density. The magnetic head of the present invention is effective for magnetic recording and reproducing devices having a recording density of 40 Gbit/inch², and is indispensable for magnetic recording and producing devices having a recording density of 70 Gbit/inch².

The foregoing invention has been described in terms of preferred embodiments. However, those skilled, in the art will recognize that many variations of such embodiments exist. Such variations are intended to be within the scope of the present invention and the appended claims.

What is claimed is:

1. A magnetoresistive head comprising a magnetoresistive element and a pair of electrodes;
wherein the magnetoresistive element comprises a laminate structure comprising an antiferromagnetic layer, a magnetization fixed layer, a free ferromagnetic layer and a nonmagnetic intermediate layer disposed between the magnetization fixed layer and the free ferromagnetic layer; and
wherein the magnetization fixed layer comprises a first magnetic layer, an antiferromagnetic coupling layer, a second magnetic layer, and an oxide layer disposed between either of the first and second magnetic layers and the antiferromagnetic coupling layer.

2. The magnetoresistive head of claim 1 wherein the oxide layer comprises a mixture layer of an oxide and a magnetic material.

3. The magnetoresistive head of claim 1 wherein the oxide layer comprises a material selected from the group consisting of FeO, Fe₃O₄, γ-Fe₂O₃, CoFe₂O₄, NiFe₂O₄, MnFe₂O₄, CrFe₂O₄, ZnFe₂O₄ and an oxide of a magnetic material made mainly of Fe.

4. The magnetoresistive head of claim 2 wherein the mixture layer comprises a material selected from the group consisting of Fe, Ni, Co, Mn, Cr, Cu, Zn, an oxide of Fe, an oxide of Ni, an oxide of Co, an oxide of Mn, an oxide of Cr, an oxide of Cu and an oxide of Zn.

5. The magnetoresistive head of claim 2 wherein the mixture layer comprises a mixture of a ferromagnetic metal and a ferromagnetic oxide wherein the ferromagnetic oxide is selected from the group consisting of FeO, Fe₃O₄, γ-Fe₂O₃, CoFe₂O₄, NiFe₂O₄, MnFe₂O_{4,} CrFe₂O₄ and ZnFe₂O₄.

6. The magnetoresistive head of claim 1 wherein one of said pair of electrodes is formed on each side of the magnetoresistive element.

7. The magnetoresistive head of claim 1 wherein a first of said pair of electrodes is formed on the top of the magnetoresistive element and a second of said pair of electrodes is formed on the bottom of the magnetoresistive element.

8. The magnetoresistive head of claim 1 further comprising an inductive head.

9. A magnetoresistive head comprising a magnetoresistive element and a pair of electrodes;
wherein the magnetoresistive element comprises a laminate structure comprising an antiferromagnetic layer, a magnetization fixed layer, a free ferromagnetic layer and a nonmagnetic intermediate layer disposed between the magnetization fixed layer and the free ferromagnetic layer; and
wherein the free ferromagnetic layer comprises a first magnetic layer, an antiferromagnetic coupling layer, a second magnetic layer, and an oxide layer disposed between either of the first and second magnetic layers and the antiferromagnetic coupling layer.

10. The magnetoresistive head of claim 9 wherein the oxide layer comprises a mixture layer of an oxide and a magnetic material.

11. The magnetoresistive head of claim 10 wherein the oxide layer comprises a material selected from the group consisting of FeO, Fe₃O₄, γ-Fe₂O₃, CoFe₂O₄, NiFe₂O₄, MnFe₂O₄, CrFe₂O₄, ZnFe₂O₄ and an oxide of a magnetic material made mainly of Fe.

12. The magnetoresistive head of claim 10 wherein the mixture layer comprises a material selected from the group consisting of Fe, Ni, Co, Mn, Cr, Cu, Zn, an oxide of Fe, an oxide of Ni, an oxide of Co, an oxide of Mn, an oxide of Cr, an oxide of Cu and an oxide of Zn.

13. The magnetoresistive head of claim 10 wherein the mixture layer comprises a mixture of a ferromagnetic metal and a ferromagnetic oxide wherein the ferromagnetic oxide is selected from the group consisting of FeO, Fe₃O₄, γ-Fe₂O₃, CoFe₂O₄, NiFe₂O₄, MnFe₂O₄, CrFe₂O₄ and ZnFe₂O₄.

14. The magnetoresistive head of claim 9 wherein one of said pair of electrodes is formed on each side of the magnetoresistive element.

15. The magnetoresistive head of claim 9 wherein a first of said pair of electrodes is formed on the top of the magnetoresistive element and a second of said pair of electrodes is formed on the bottom of the magnetoresistive element.

16. The magnetoresistive head of claim 9 further comprising an inductive head.

17. A magnetic disk device comprising a magnetoresistive head and magnetic disk;
wherein the magnetoresistive head comprises a magnetoresistive element and a pair of electrodes;
wherein the magnetoresistive element comprises a first laminate structure comprising an antiferromagnetic layer, a magnetization fixed layer, a free ferromagnetic layer and a nonmagnetic intermediate layer disposed between the magnetization fixed layer and the free ferromagnetic layer; and
a second laminate structure comprising a first magnetic layer, an antiferromagnetic coupling layer, a second magnetic layer, and an oxide layer disposed between either of the first and second magnetic layers and the antiferromagnetic coupling layer.

18. The magnetic disk device of claim 17 wherein said magnetization fixed layer comprises said second laminate structure.

19. The magnetic disk device of claim 17 wherein said free ferromagnetic layer comprises said second laminate structure.
